(19) United States
(12) Patent Application Publication
(10) Pub. No.: US 2012/0288231 A1
(43) Pub. Date: Nov. 15, 2012

(54) LASER PACKAGE INCLUDING TILTED LASER AND METHOD OF USING SAME

(75) Inventors: Jun Zheng, Houston, TX (US); Wen-Yen Hwang, Sugar Land, TX (US); Hung-Lun Chang, Sugar Land, TX (US)

(73) Assignee: APPLIED OPTOELECTRONICS, INC., Sugar Land, TX (US)

(21) Appl. No.: 13/105,286

(22) Filed: May 11, 2011

(51) Int. Cl. G02B 6/32

(52) U.S. Cl. 385/33

(57) ABSTRACT

In a laser package, a tilted laser causes laser light to be coupled into an optical fiber at an angle relative to a fiber axis of the optical fiber. The tilted laser emits laser light at an angle relative to a lens axis of a lens such that the lens directs and focuses the laser light at the angle relative to the fiber axis. Tilting the laser allows the laser light to be coupled into the optical fiber substantially parallel to or aligned with the core of the fiber while causing back reflection to be directed away from the laser, thereby improving coupling efficiency and minimizing feedback. The tilted laser may be coupled to an angle polished fiber, for example, in a laser package such as a TO can type laser package, a butterfly type laser package, or a TOSA type laser package.

### TECHNICAL FIELD

The present invention relates to laser packaging and in particular, to a laser package including a tilted laser for coupling laser light into an optical fiber at an angle relative to a fiber axis.

### BACKGROUND INFORMATION

The following descriptions and examples are not admitted to be prior art by virtue of their inclusion within this section.

Semiconductor lasers are used in a variety of applications, such as high-bit-rate optical fiber communications. To provide optical fiber communications, lasers are optically coupled to fibers to enable modulated light output from the laser to be transmitted into the fiber. Various modules, assemblies or packages are used to hold and align the laser, other optical components (e.g., collimation and coupling lenses, isolators, and the like), and optical fiber such that the laser is optically coupled to the fiber. The process of aligning an optical fiber to a laser and fixing it in place is sometimes referred to as fiber pigtailing.

Standard laser package types include butterfly laser packages and coaxial or TO (transistor outline) can laser packages. In a TO can laser package, for example, the laser (e.g., a laser diode) and the light-receiving end of the optical fiber may be mounted together within a substantially cylindrical housing. The laser may be mounted on a laser sub-mount on a TO can post of a TO can header. The fiber end may be disposed in a rigid cylindrical ferrule, which may be welded to the TO can housing after the laser and the optical fiber are aligned. The TO can housing may also contain other related components, such as a lens and a monitor photodiode, and may be hermetically sealed.

In this and other types of laser packages, one problem that often arises when a laser is coupled to an optical fiber is back reflection from the end face of the fiber back into the laser cavity. One way to reduce back reflection is to use an angle-polished fiber, which has its end surface polished to a fiber end angle (e.g., 8°) slightly off of the plane normal to the axis of the fiber core. Light from the laser that reflects off of the fiber end, instead of being coupled into the fiber, is reflected at an angle with respect to the axis of the fiber and is thus not reflected back into the laser cavity. One drawback of this approach, however, is that coupling efficiency may be reduced. A primary reason for this reduction in coupling efficiency is that the angled fiber end causes light coupled into the fiber core at the angled end to be bent at a certain refraction angle due to the different indices of refraction of the fiber and surrounding medium (e.g., air). As a result, the light is not coupled into the fiber substantially parallel to or aligned with the axis of the fiber core, which reduces coupling efficiency.

One solution to this problem of efficient coupling with an angle polished fiber is to angle the optical fiber such that laser light is coupled substantially parallel to the axis of the fiber core while being reflected at an angle to avoid back reflection. One example of such a technique is described in greater detail in U.S. Patent Application Publication No. 2009/0016683, which is incorporated herein by reference. Although this may be effective to reduce back reflection and improve coupling efficiency, mounting the angled optical fiber presents difficulties, particularly in a TO can housing. Another solution to this problem is to offset the laser from the axis of the lens. Although this technique also may be effective to reduce back reflection and improve coupling efficiency, alignment with the optical fiber with an offset laser presents unique challenges because the focal point changes when the laser is offset from the lens and fiber axis. Techniques for alignment of an offset laser are described in greater detail in U.S. Patent Application Publication No. 2010/0007884, which is incorporated herein by reference.

### BRIEF DESCRIPTION OF THE DRAWINGS

These and other features and advantages will be better understood by reading the following detailed description, taken together with the drawings wherein:

FIG. 1 is a side schematic view of a tilted laser optically coupled with an optical fiber via a lens, consistent with embodiments of the present invention.

FIG. 2 is a side schematic view of a laser package including a tilted laser coupled to an optical fiber via a lens, consistent with one embodiment of the present invention.

FIG. 3 is a graph illustrating L-I curves for lasers coupled with an optical fiber with back reflection and with reduced back reflection.

FIG. 4 is a graph illustrating the first derivative (dL/dI) of the L-I curves shown in FIG. 3.

### DETAILED DESCRIPTION

In a laser package, consistent with embodiments of the present disclosure, a tilted laser causes laser light to be coupled into an optical fiber at an angle relative to a fiber axis of the optical fiber. The tilted laser emits laser light at an angle relative to a lens axis of a lens such that the lens directs and focuses the laser light at the angle relative to the fiber axis. Tilting the laser allows the laser light to be coupled into the optical fiber substantially parallel to or aligned with the core of the fiber while causing back reflection to be directed away from the laser, thereby improving coupling efficiency and minimizing feedback. The tilted laser may be coupled to an angle polished fiber, for example, in a laser package such as a TO can type laser package, a butterfly type laser package, or a TOSA type laser package. Such laser packages may be used, for example, in optical transmitters to transmit optical signals through optical fibers.

As used herein, the terms “substantially” and “about” refer to within tolerances, margins of error, and/or deviations acceptable to one skilled in the art. For example, “substantially parallel” refers to parallel within some acceptable deviation and does not require an exact parallel relationship and “substantially aligned” refers to aligned with some acceptable deviation and does not require exact alignment. As used herein, “tilted laser” refers to a laser with an optical axis (i.e., an axis perpendicular to a light emitting face of the laser) that forms an angle relative to a lens axis and/or a fiber axis.

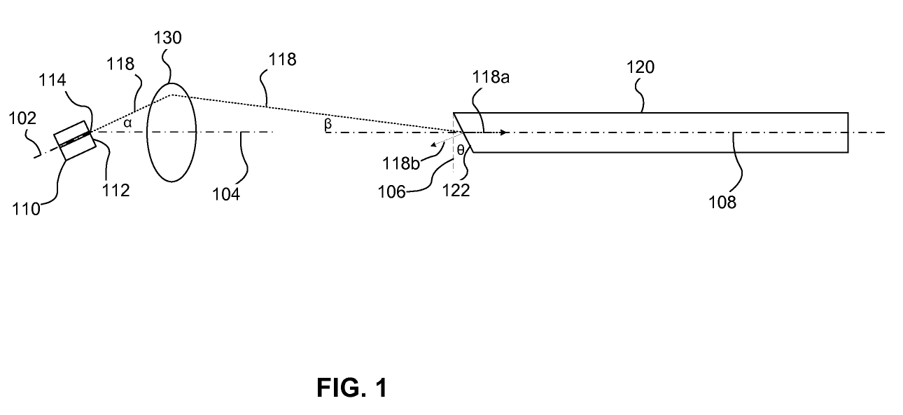

Referring to FIG. 1, a tilted laser 110 may be coupled to an optical fiber 120 via a lens 130. The tilted laser 110 is tilted such that an optical axis 102 substantially perpendicular to the light emitting face 112 of the laser 110 forms an angle α with a lens axis 104 passing substantially through a center of the lens 130. The optical fiber 120 has an angled end face 122 that forms a fiber end angle θ relative to a plane 106 normal to a fiber axis 108 passing through a core of the optical fiber 120. The tilted laser 110, lens 130 and optical fiber 120 are positioned such that laser light 118 emitted from the tilted laser 110 is focused onto a core region of the optical fiber 120 at a coupling angle β relative to the fiber axis 108.

At least a portion of the laser light 118a is coupled into the optical fiber 120 and is directed predominantly along the core of the optical fiber 120. As a result of the coupling angle β of the laser light 118 and the fiber end angle θ of the face 122 of the optical fiber 120, the laser light 118a entering the optical fiber 120 refracts substantially into alignment with the fiber axis 108. The laser light 118b that is not coupled into the optical fiber 120 is reflected at an angle to avoid feedback into the cavity of the laser 110.

The tilted laser 110 may include various types of diode lasers having a light emitting region 114 on the light emitting face 112. The lens 130 may include a spherical lens or other such lens used to focus laser light into an optical fiber. The optical fiber 120 may include an angle-polished fiber with an end face having a fiber end angle θ of about 8° to 10°. Other types of lasers, lens, optical fibers, or additional components may be used to couple the laser light into the optical fiber.

The tilted laser 110, the lens 130 and the optical fiber 120 may also be positioned such that the light emitting region 114 of the tilted laser 110, the lens axis 104, and the fiber axis 108 are substantially aligned. The laser 110 thus emits laser light 118 from the light emitting region 114 on the light emitting face 112 of the laser at the tilt angle α relative to the lens axis 104. The lens 130 directs and focuses the laser light 118 at the coupling angle β relative to the fiber axis 108 such that the light 118a coupled into the optical fiber 120 refracts into substantial alignment with the fiber axis 108. If the laser light 118 were directed along the fiber axis 108 (e.g., β=0°), the incidence angle of the laser light 118 would be equal to the fiber end angle θ and the difference in the indices of refraction between the medium of the fiber 110 (e.g. fused silica) and the surrounding medium (e.g., air) would cause the coupled light 118a to enter the optical fiber 110 at a refraction angle that is not substantially aligned with the fiber axis 108, which adversely affects the coupling efficiency. Therefore, the coupling angle β is the angle that will increase the incidence angle of the laser light 118 against the angled face 122 sufficient for the coupled light 118a to refract at an increased refraction angle such that the coupled light 118a is substantially aligned with the fiber axis 108. The extent of the alignment may vary depending upon the desired or acceptable coupling efficiency.

For the coupled light 118a to be substantially aligned with the fiber axis 108 according to one embodiment, the refraction angle should generally correspond to the fiber end angle θ. According to one embodiment, therefore, the coupling angle β may be determined according to the following equation:

$$β \approx θ ( \frac{{n}_{f}}{{n}_{a}} - 1 ) \qquad Eq . ( 1 )$$

wherein θ is the fiber end angle, n_{f} is the index of refraction of the fiber, and nₐ is the index of refraction of the surrounding medium from which the light is coupled into the fiber.

Where the surrounding medium is air, the angle β may be determined according to the following equation:

β≈θ(n_{f}−1) Eq. (2)

One example of an angle-polished optical fiber may have a fiber end angle θ of about 8° and may be made of fused silica with an index of refraction n_{f} of about 1.47. According to this example, the coupling angle β may be about 3° to 3.8° to provide substantial alignment of the coupled light 118a with the fiber axis 108.

Thus, the tilt angle α is the angle that will result in the desired coupling angle β when the emitted laser light 118 is directed and focused by the lens 130. The tilt angle α may depend on the location of the laser 110 relative to the lens 130, the type of lens 130 and the refraction in the lens 130. In one example where the optical fiber 120 has an end face with a fiber end angle θ of about 8° and the desired coupling angle β is about 3° to 3.8°, the tilt angle α may be about 10° relative to the lens axis 104.

By tilting the laser 110 to increase the incidence angle and the refraction angle (e.g., instead of offsetting the laser relative to the lens 130), the light emitting region 114 on the light emitting face 112 of the tilted laser 110 may be substantially aligned with the lens axis 104 and the fiber axis 108. With such an alignment, the focal point of the laser light 118 on the angled face 122 of the optical fiber 120 remains substantially in the same location even if the laser 110 were rotated or angularly displaced relative to the optical fiber 120. Tilting the laser 110 may also be easier to accomplish than angling the optical fiber 120 to achieve alignment of the coupling light with the fiber axis.

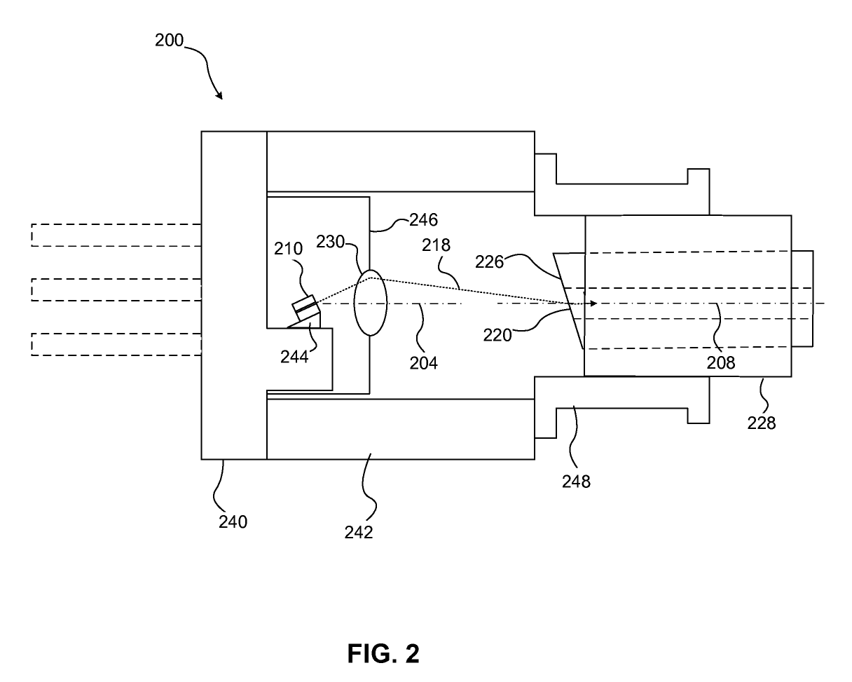

Referring to FIG. 2, a laser package 200, such as a TO can type laser package, includes a tilted laser 210 coupled to an optical fiber 220 using a lens 230 to direct the emitted laser light at the coupling angle β relative to a fiber axis 208 of the optical fiber 220. The laser package 200 includes a laser package housing, for example, formed by a TO can header 240 and a substantially cylindrical TO can housing 242. In the illustrated embodiment, the tilted laser 210 (e.g., a laser diode) is mounted to the TO can header 240 and within the TO can housing 242. The laser package 200 may also include a sub-mount 244 (e.g., located on the TO can header 240) for mounting the tilted laser 210. The sub-mount 244 may include an angled surface that provides the desired tilt angle α for the tilted laser 210. The lens 230 is mounted in front of the tilted laser 210 in a lens mounting structure 246.

In the exemplary embodiment, the optical fiber 220 is coupled to the TO can housing 242 of the laser package 200 using a coupling sleeve 248. The optical fiber 220 may be located in one or more ferrule portions 226, 228 that are coupled to the fiber coupling sleeve 248. The TO can housing 242 and the coupling sleeve 248 may be configured to move relative to each other during alignment and may be welded to secure the optical fiber 220 into alignment with the tilted laser 210. A conventional alignment process may be used to align the optical fiber 220 with the emitted laser light 218, for example, by searching for a maximum power coupled into the optical fiber. A conventional mounting process may also be used to mount the optical fiber 220 to the laser package 200, for example, by welding the coupling sleeve 248 to the housing 242.

Although a TO can type laser package is shown, a tilted laser, lens, and optical fiber may be similarly arranged in other types of laser packages including laser package housings and sub-mounts. Other optical components, such as monitor photodiodes, may also be provided within the laser package.

In operation, as discussed above, the tilted laser 210 emits the laser light 218 at the tilt angle α relative to a lens axis 204 of the lens 230. The lens 230 focuses and directs the tilted laser light 218 at the coupling angle β relative to the fiber axis 208 of the optical fiber 220 such that the laser light 218 is coupled into the angled face of the optical fiber 220 substantially aligned with the fiber axis 208, as described above.

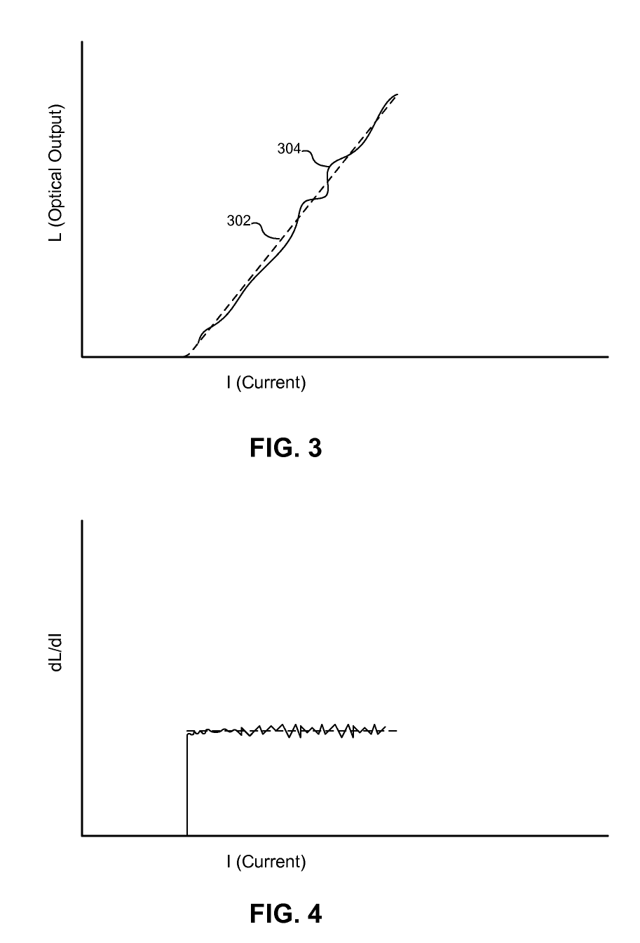

FIGS. 3-4 illustrate the possible performance improvements when using a tilted laser as described herein. FIG. 3 shows a plot of optical output (L) as a function of current (I), referred to as an L-I curve, which represents the electrical to optical conversion in the laser and thus the L-I efficiency. Without feedback, the ideal L-I curve 302 is substantially linear. When back reflection occurs from a coupled optical fiber, the feedback in the laser may produce a non-linear L-I curve 304. FIG. 4 shows the first derivatives of the L-I curves 302, 304, which represent the slope efficiency of the L-I curve and are more sensitive to the non-linearities. The first derivatives of the L-I curves 302, 304 thus illustrate “kinks” in the L-I curve of a laser with feedback as compared to the L-I curve of a laser without feedback.

Accordingly, the laser package with a tilted laser, consistent with embodiments of the present invention, may facilitate alignment of coupled light from a laser with a fiber axis in an angle polished optical fiber, improve coupling efficiency, and minimize back reflection or feedback.

Consistent with one embodiment, a system includes an optical fiber having an angled end face and a tilted laser configured to emit laser light. A light emitting region of the tilted laser is substantially aligned with a fiber axis passing through a core of the optical fiber. The system also includes a lens located between the tilted laser and the optical fiber. The light emitting region of the tilted laser is substantially aligned with a lens axis passing through a center of the lens. The laser light emitted from the tilted laser is angled at a tilt angle relative to the lens axis such that the laser light is focused and directed by the lens to the angled end face of the optical fiber at a coupling angle relative to the fiber axis such that the laser light is coupled into the optical fiber substantially aligned with the fiber axis and such that reflected light is reflected back at an angle relative to the lens axis.

Consistent with another embodiment, a laser package is used with an optical fiber having an end face angled at a fiber end angle with respect to a plane normal to an axis of the fiber. The laser package includes a laser package housing including a fiber receiving region configured to receive an optical fiber coupled to the laser package housing and a tilted laser mounted within the laser package housing and configured to emit laser light. The laser package also includes a lens located between the laser and the fiber receiving region. The lens is configured to focus and direct the laser light into an angled end face of an optical fiber received in the fiber receiving aperture. The tilted laser is tilted at a tilt angle relative to a lens axis passing through a center of the lens such that laser light emitted from the tilted laser is angled relative to the lens axis and is focused and directed by the lens to the angled end face of the optical fiber at a coupling angle relative to a fiber axis passing through a core of the optical fiber.

Consistent with a yet another embodiment, a method is provided for coupling laser light into an optical fiber having an end face angled at a fiber end angle with respect to a plane normal to an axis of the fiber. The method includes: providing a laser package including a laser package housing, a tilted laser located in the laser package housing, a lens located in the laser package housing, and an optical fiber coupled to the laser package housing; emitting laser light from the tilted laser at a tilt angle relative to a lens axis passing through a center of the lens; and focusing and directing the laser light from the lens to an angled end face of the optical fiber, wherein the laser light is angled at a coupling angle relative to a fiber axis passing through a core of the optical fiber such that reflected light is reflected back at an angle relative to the lens axis.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A system comprising:
an optical fiber having an angled end face;
a tilted laser configured to emit laser light, wherein a light emitting region of the tilted laser is substantially aligned with a fiber axis passing through a core of the optical fiber; and
a lens located between the tilted laser and the optical fiber, wherein the light emitting region of the tilted laser is substantially aligned with a lens axis passing through a center of the lens, and wherein the laser light emitted from the tilted laser is angled at a tilt angle relative to the lens axis such that the laser light is focused and directed by the lens to the angled end face of the optical fiber at a coupling angle relative to the fiber axis such that the laser light is coupled into the optical fiber substantially aligned with the fiber axis and such that reflected light is reflected back at an angle relative to the lens axis.

2. The system of claim 1 wherein the end face of the optical fiber is angled with a fiber end angle of about 8°.

3. The system of claim 1 wherein the tilted laser is tilted such that the laser light emitted from the tilted laser is angled relative to the lens axis at a tilt angle of about 10°.

4. The system of claim 1 wherein the tilted laser is tilted and located relative to the lens such that the laser light directed from the lens is angled relative to the fiber axis at a coupling angle of about 3° to 3.8°.

5. The system of claim 1 wherein the coupling angle (β) relative to the fiber axis is determined according to the equation
$$β \approx θ ( \frac{{n}_{f}}{{n}_{a}} - 1 ) ,$$
wherein θ is the fiber end angle, n_{f} is the index of refraction of the fiber, and nₐ is the index of refraction of a medium from which the light is coupled into the fiber.

6. A laser package for use with an optical fiber having an end face angled at a fiber end angle with respect to a plane normal to an axis of the fiber, the laser package comprising:
a laser package housing including a fiber receiving region configured to receive an optical fiber coupled to the laser package housing;
a tilted laser mounted within the laser package housing and configured to emit laser light;
a lens located between the laser and the fiber receiving region, the lens being configured to focus and direct the laser light into an angled end face of an optical fiber received in the fiber receiving aperture, wherein the tilted laser is tilted at a tilt angle relative to a lens axis passing through a center of the lens such that laser light emitted from the tilted laser is angled relative to the lens axis and is focused and directed by the lens to the angled end face of the optical fiber at a coupling angle relative to a fiber axis passing through a core of the optical fiber.

7. The laser package of claim 6, further comprising a sub-mount located within the laser package housing, wherein the tilted laser is mounted on the sub-mount.

8. The laser package of claim 7, wherein the sub-mount includes an angled surface providing the tilt angle of the tilted laser.

9. The laser package of claim 8, wherein the laser package housing includes a TO can housing and a TO can header, and wherein the sub-mount is located on the TO can header.

10. The laser package of claim 6, wherein the laser package housing includes a TO can housing.

11. The laser package of claim 6, wherein the end face of the optical fiber is angled with a fiber end angle of about 8°, wherein the tilted laser is tilted such that the laser light emitted from the tilted laser is angled relative to the lens axis at a tilt angle of about 10°, and wherein the laser light is coupled into the optical fiber at a coupling angle of about 3° to 3.8° relative to the fiber axis.

12. The laser package of claim 6, wherein the coupling angle (β) relative to the fiber axis is determined according to the equation
$$β \approx θ ( \frac{{n}_{f}}{{n}_{a}} - 1 ) ,$$
wherein θ is the fiber end angle, n_{f} is the index of refraction of the fiber, and nₐ is the index of refraction of a medium from which the light is coupled into the fiber.

13. The laser package of claim 6, wherein a light emitting region of the tilted laser is substantially aligned with the fiber axis.

14. The laser package of claim 6, wherein a light emitting region of the tilted laser is substantially aligned with the fiber axis and with the lens axis.

15. A method of coupling laser light into an optical fiber having an end face angled at a fiber end angle with respect to a plane normal to an axis of the fiber, the method comprising:
providing a laser package including a laser package housing, a tilted laser located in the laser package housing, a lens located in the laser package housing, and an optical fiber coupled to the laser package housing;
emitting laser light from the tilted laser at a tilt angle relative to a lens axis passing through a center of the lens; and
focusing and directing the laser light from the lens to an angled end face of the optical fiber, wherein the laser light is angled at a coupling angle relative to a fiber axis passing through a core of the optical fiber such that reflected light is reflected back at an angle relative to the lens axis.

16. The laser package of claim 15, wherein the end face of the optical fiber is angled with a fiber end angle of about 8°, wherein the tilted laser is tilted such that the laser light emitted from the tilted laser is angled relative to the lens axis at a tilt angle of about 10°, and wherein the laser light is coupled into the optical fiber at a coupling angle of about 3° to 3.8° relative to the fiber axis.

17. The laser package of claim 15, wherein the coupling angle (β) relative to the fiber axis is determined according to the equation
$$β \approx θ ( \frac{{n}_{f}}{{n}_{a}} - 1 ) ,$$
wherein θ is the fiber end angle, n_{f} is the index of refraction of the fiber, and nₐ is the index of refraction of a medium from which the light is coupled into the fiber.
